(19) United States
(12) Patent Application Publication
(10) Pub. No.: US 2004/0183343 A1
(43) Pub. Date: Sep. 23, 2004

(54) Seat technology

(76) Inventor: Paul C. Probst, Plymouth, MN (US)

Correspondence Address: JOEL D. SKINNER, JR., SKINNER AND ASSOCIATES, 212 COMMERCIAL ST., HUDSON, WI, 54016, US

(21) Appl. No.: 10/766,798

(22) Filed: Jan. 28, 2004

Related U.S. Application Data
(60) Provisional application No. 60/444,330, filed on Jan. 30, 2003.

(51) Int. Cl. B62J 1/00

(52) U.S. Cl. 297/195.1

(57) ABSTRACT

A bicycle seat that vibrates/oscillates/kneads/massages the riders anatomy via intermittent digitally controlled frequencies or by way of an on-off activation switch or by sensor/weight activation. This allows rider seat massage to maximize comfort, minimize soreness/numbness at the perineum, ischial tuberosities and/or gluteus maximus muscles when on seat for varying periods of time. A vibratory or oscillatory lightweight tube is integrated within the underside of the seat front to back, so as to be one with the hard plastic shell-undercarriage and/or metal rod infrastructure of the seat. Seat massage can be vibratory/oscillatory Rpm's or frequencies similar to frequency vibration/oscillation of hand held vibrators up to ultrasonic toothbrushes having much higher strokes per minute. The massage frequencies are conducted within the tube and seat therefore the entire seat vibrates/oscillates thus massaging the seated rider. Optionally, the seat may vibrate/oscillate automatically for one-three minutes at intervals by virtue of sensor activation in the padding of the seat displaced with body weight. Seat may be programmable to allow various wave length frequencies of vibration/oscillation. It is the first and only smart/therapeutic bicycle seat. These invention principles also apply to motorcycle saddles/seats, snowmobiles, stationary bikes and other exercise equipment.

### CROSS-REFERENCE TO RELATED APPLICATIONS IF ANY

This application claims the benefit under 35 U.S.C. §119(e) of co-pending U.S. Provisional Patent Application Serial No. 60/444,330, filed Jan. 30, 2003, which is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND

1. Field

The invention relates seats, more particularly seats for bicycles, motorcycles, snowmobiles and stationary bicycles, and most specifically seats using electronic power source(s) to activate saddle vibration, oscillation, rolling, kneading, percussion, compression therapeutic massage replicated actions, or with heating, cooling, electronic cancellation of “vibration when in excess” as programmed functional options for actions of the seat/saddle while the bicycle or motorcycle is used.

2. Background Information

Present bicycle seats consist of half of a concave clamshell made of a hard plastic or composite infrastructure. Foam, gel or other is used as padding and is covered by leather or vinyl pulled over outside surface of plastic shell and secured on the underside lip of shell with permanent cement and/or staples around the entire plastic shell seat infrastructure. Inside of the shell is a concave area formed by the plastic shell with two ¼ inch to ⅛ inch metal rods running 95% of the length, (front to back) within the concave shell. The rods are both infrastructure support and standardized in specifications to allow attachment by clamping of seat rods to standard dimension seat posts of bicycle. Configuration applies to bicycles and their seats designed for recreational, anatomically correct, gender specific, comfort, mountain, hybrid, touring, tandem and racing.

Present motorcycle seats/saddles consist of a flat (approximately ¼ inch thick) plastic or composite basepan (tailored to fit and is attached to the motorcycle frame) with foam, gel or other material covering basepan shape or configuration, thus providing padding to be covered by leather, vinyl or other material which is sat on while riding.

Review of prior art confirms that accepted seat/saddle designs and configurations to date deal only with mechanical and material elements to address the comfort/discomfort issues of sitting on the seat/saddle for varying periods of time while riding. Varying degrees of soreness/numbness from mild to severe at the crotch, perineum and associated bones/muscles at sitting haunches can be such as to cause the bicyclist/motorcyclist periods of time too sore to sit on seat and/or ride. It is not out of the realm of possibilities to project that, riding without addressing this soreness could be a safety concern caused by the mental distraction of soreness rather than concentrating on the direction of where and how you are riding.

It is an aspect of the present invention to minimize soreness and or numbness/maximize comfort to provide the rider means of anatomical massage through intermittent or constant seat vibration/oscillation and/or massage while the bike or motorcycle is in use. It is commonly understood and described in literature and accepted that vibratory/oscillation therapeutic massage soothes and or minimizes the anatomical soreness of muscles and surrounding massaged area. The present invention is the first therapeutic bicycle/motorcycle seat to minimize soreness at the perineum, ischial tuberosities and gluteus maximus muscles. Vascular circulation and or oxygenation maybe increased and node draining in muscles are optimized. Bodyweight placement on all prior art seats and saddles, occlude vascularization, oxygenation and muscle node drainage of toxins. Accumulation of toxins in muscles ultimately is the resulting physiologic event that causes muscle soreness and or numbness in any body muscle. Another common ailment is also a well documented (Irwin Goldstein, MD) problem with bicycle seats in particular that can lead to prostrate damage in males caused by seated weight placement on a bicycle seat over years of use.

A further aspect for motorcycle saddles in some models where the engine runs rough causing too much vibration at the frame and saddle may include an isolation, buffering or redirecting mechanism at the saddle basepan, in integration with the saddle so as non-wanted vibration is cancelled out electronically synchronized to the motorcycle engine's Rpm's. This now smoothly ridden saddle allows vibration to come through as programmed intermittently when desired, stimulating increased blood circulation/oxygenation node drainage thus minimizing soreness/numbness otherwise providing a more comfortable ride.

A further aspect for motorcycle saddles is using appropriate heating or cooling elements/means with current state of the art commonly available instruments using the engine and power from battery/generator.

A further aspect of the invention for bicycle seats is to provide Ni-Cad battery rechargeable means for the power source to allow massage over a three plus hour ride time between recharging. DC power socket will allow use with or without the cord. Solar power recharging and bike motion power recharging may be used to extend operation time. In the case of motorcycle seats the engines generator and subsequently the battery power allowing massage throughout the ride or when desired.

Further aspects of the invention for bicycle saddles/seats is combining seat oscillation with a nodulized mechanism integrated at seat/seat post or is combining seat oscillation with integrated mechanical or electrical shock absorber within the seat/seat post.

A further aspect for motorcycle and bicycles, is saddle integration of electrodes allowing conduction of electrical current via EMS electric muscle stimulation, already used in state of art pain management devices. This maybe an ideal alternative to oscillation or roller wheels for minimizing soreness/numbness and maximizing comfort.

For these and other reasons, a need exists for the present invention.

All US patents and patent applications, and all other published documents mentioned anywhere in this application are hereby incorporated by reference in their entirety.

### BRIEF SUMMARY

The present invention provides a seat apparatus and method which is practical, reliable, accurate and efficient, and which is believed to fulfil a need and to constitute an improvement over the background technology.

The present invention consists of a plastic or metal tube that vibrates/oscillates/massages upon activation and is integrated within the underside side carriage of presently designed bicycle and motorcycle seats described above. The tube is affixed so the seat and tube are one. Optionally to optimize massage as needed, it may be encased in a molded concave tube tunnel of the seat's plastic shell underside or in the case of motorcycle seats, channeling on integrated tracks or molded concave tube tunnels or tracks through the foam or gel adjacent to the seat covering material and seated rider running front to back. For bicycle seats, the vibratory/oscillating tube and or tube tunnel is approximately 7.5 inches long by 1.75 inches in diameter at it's widest and will weigh less than 1.5 lbs. The same approximate dimensions, varying as dictated on bicycle saddle type, apply to the tracks and tracking channels when roller wheel/ball functions are used on motorcycle seats and larger bicycle seats to minimize soreness and maximize comfort. Roller-wheels and tracks may weigh in the 1.5 to 10.0 lbs. or more.

For larger motorcycle seats, the oscillation tube/tube channels and or track(s) for rotation of roller-wheels/balls will run front to back for double seats (driver and passenger) ranging from 24 inches to 34 inches in length approximately dependent on motorcycle model. Typical seat widths for motorcycle saddles run 11 to 16 inches. Single or solo saddles run 19 to 22 inches in length with the same basic widths as doubles. Saddle length and widths primarily dictate if multiple oscillation tube/tube channels or rollerball track/track channels are required for optimal function.

The bicycle seat's power optionally is configured to allow vibratory/oscillatory tube recharging while tube is affixed to the seat on bike OR snapped in or out/locked in or out for recharging remotely or replacing all together when power source is diminished beyond the ability to be recharged. Motorcycles seat power comes form engine battery/generator.

Similar vibratory/oscillatory/rolling massage designed instruments and their dimensions include ultrasonic toothbrush for brushing teeth/massaging gumbs and other retail and consumer plastic hand held vibrators/oscillation instruments for muscle massage approximately 7 inches long by 1.5 inches in diameter.

A primary advantage of present invention is anatomical soreness and or numbness is minimized while seated and riding the bicycle/motorcycle, causing soreness relief currently only by stopping to ride altogether, riding for shorter distance to minimize soreness or by standing to off-load seated body weight thus minimizing soreness and maximize comfort.

Another advantage of present invention is a seat sensor optional design to cause activation automatically providing pre-selected vibratory periods of massage as long as bicycle/motorcycle seat is seated upon. A “smart seat” starts massage requiring no thought process or manual on/off while riding for in the case of a bicycle the power is recharged as necessary. Digital and programmable controls or control bar activate and control all functions including seat sensor with automatic versions for both bicycles and motorcycles to massage, enabling the optimal comfortable ride.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

The present invention, and the manner and process of making and using it, will be better understood by those skilled in the art by reference to the following drawings.

FIG. 1 is a bottom view of bicycle seat and rod infrastructure with placement of vibratory/oscillatory tube, tube tunnel as part of or affixed to seat's plastic shell and rod contact as optimal for seat vibration/oscillation. Recharging connection and controls are viewed and overall approximate seat dimensions.

FIG. 2 is a side view of seat with rods and placement of tube also showing digital or rheostat control and in place recharging connection

FIG. 3a. is rear view of integrated concave tube tunnel, oscillating tube in place with digital or rheostat control and rod infrastructure

FIG. 3b. is a blow up view of possible but not all-inclusive digital controls for selection of functions and or programs

FIG. 4a. is a bottom view front to back of tube design that will vary in dimensions as necessary to work with standard recreational bicycle seat, racing seat or anatomically correct seat and any other selected saddle types.

FIG. 4b. is a side view front to back of tube design calling out recharging connection and controls and approximate dimensions

FIG. 4c. is an rear-end view of oscillating tube, tube tunnel and controls with approximate dimensions

FIG. 5 is a graphic of the seat, oscillating tube, controls and seat padding with sensor placement for vibration activation vis-a-vis body weight placement.

FIG. 6 is a bottom view of motorcycle seat: Roller wheel or ball and track as alternative or in addition to oscillation/vibration functions. Maybe integrated also with large recumbent bike seats and backs or other large bicycle comfort type seat configurations.

FIG. 7 is a side view of motorcycle seat: Roller wheel or ball and track alternative or addition. May be integrated also with recumbent bike seats and backs or other large comfort bicycle seat type configurations.

FIG. 8 is an end view of motorcycle seat: Digital Programmable Control Panel and Backrest with roller wheel or ball and track alternative or addition. Maybe integrated also with large recumbent bike seats and backs or other large comfort bicycle seat type configurations

### DETAILED DESCRIPTION

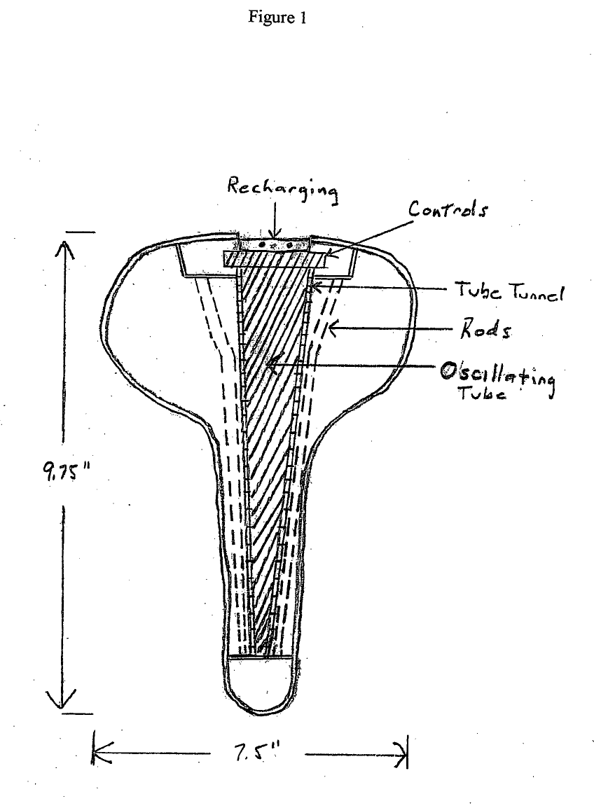

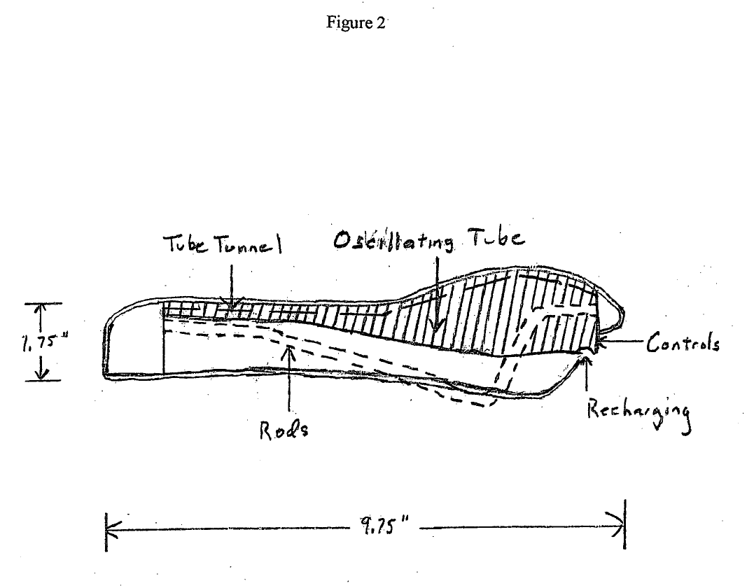

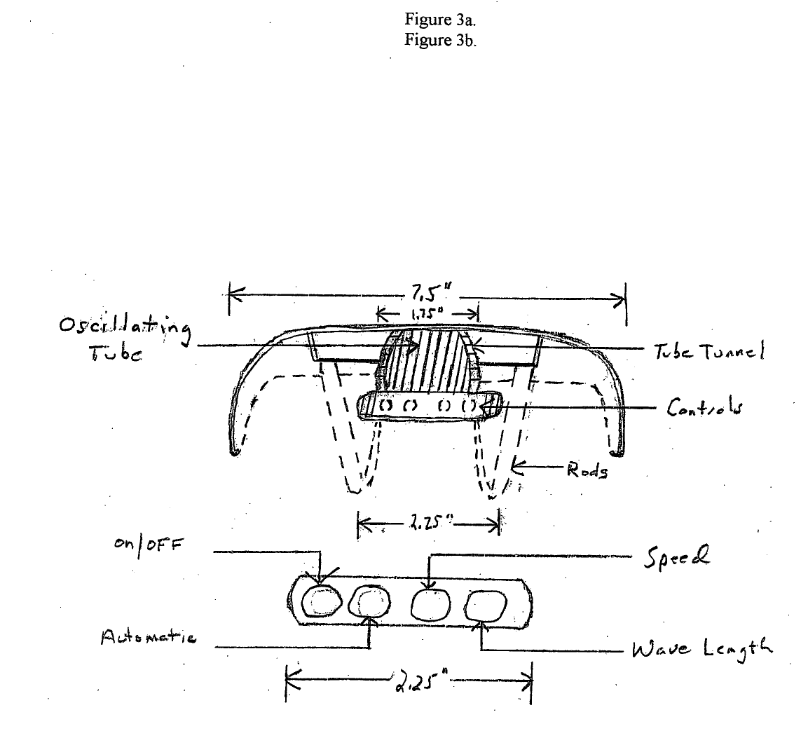

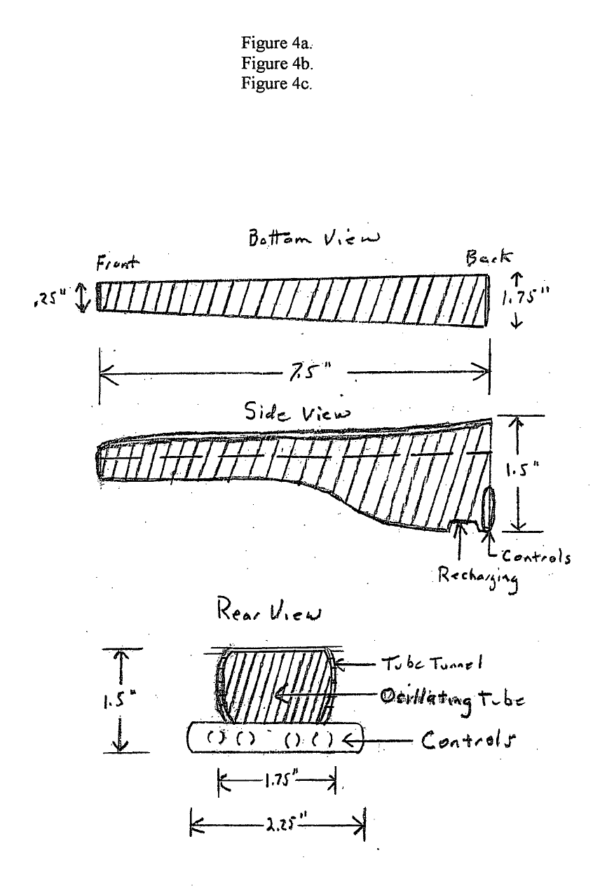

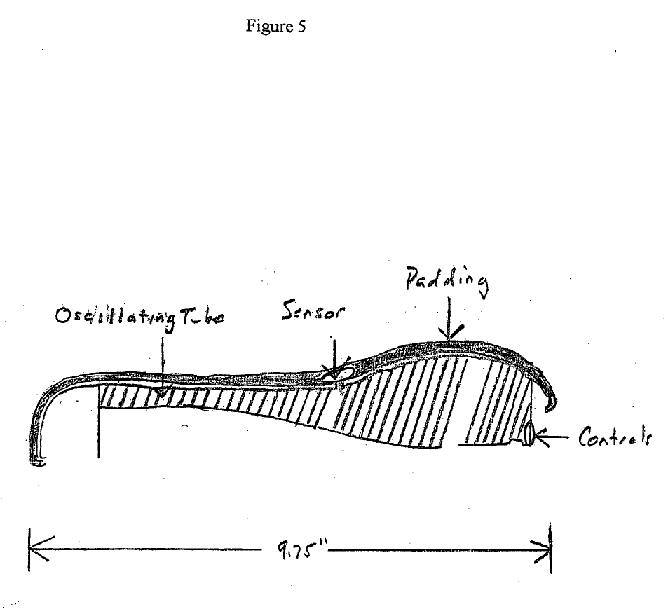

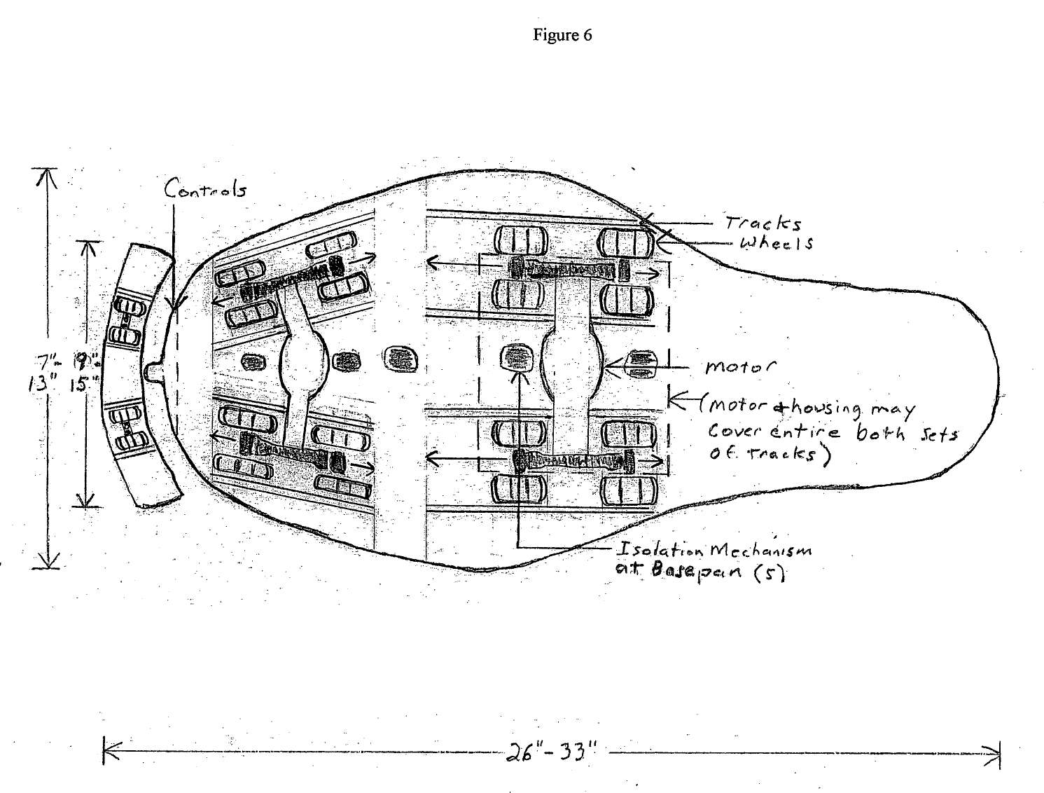

The present invention is a electronically powered vibratory/oscillatory tube in the preferred embodiment affixed/integrated within a bicycle seat's undercarriage/plastic shell having intermittent contact points with metal rod seat infrastructure also part of the seat's undercarriage. FIGS. 1-3a./3b. show the tube's integration in respective seat views of Bottom View FIG. 1, Side View FIG. 2, and Rear View FIG. 3a./3b. The vibratory/oscillatory tube configuration Views are in FIG. 4a/4b./4c. FIG. 5 is a View of seat sensor placement within seats topside padding, allowing seat oscillation only when body weight is actually on seat. An alternative embodiment could just as easily have the tube as only part of the plastic underside seat shell and have no contact with the metal rod infrastructure. Yet another embodiment for larger bicycle saddles and or recumbent saddles and backs may have integrated roller-wheels and tracks as necessarily modified and described in more detail for motorcycle saddles seen in FIGS. 6-8.

In the present invention the seat's vibration/oscillation will be in a range of strokes per minute. Said range of strokes maybe as high as ultrasonic frequency 18,000 strokes per minute like that of electronic toothbrushes or as low as more traditional hand held vibratory instruments for muscle massage having 1,100 to 5,700 strokes per minute. Optimal node drainage and maximum comfort is approximately 2,800 RPM oscillation. The bicycle seat's underside tube tunnel and vibratory/oscillatory tube is approximating 7.5 inches long, 1.75 inches in diameter. The concave tube tunnel integrated in seat underside shell will mate up con-jointly with the vibratory/oscillatory tube made of a plastic or aluminum. At various points where necessary the tube tunnel and/or tube will contact the metal rod infrastructure as needed to optimize vibration/oscillation. Oscillating tube is snapped in or out or locked in/out of the tube tunnel.

The vibratory/oscillatory seat and tube containing the vibrating/oscillating components and rechargeable Ni-Cad battery, will have outside design varying in size, dimensions and configurations matching each of the most bicycle seat types; standard, gender specific, gel filled, spring supported, foam filled and racing seat configurations. For the standard recreational bicycle seat, in FIG. 4a.4b./4c. having more oscillating tube detail, the tube size integrated into the seat on underside approximates 7.5 inches long by 1.75 inches in diameter and will weigh less than 1.5 pounds.

The seat vibratory/oscillatory activation is a simple digital on/off. Alternatively a digital control or rheostatic control can be preset at the beginning of a ride to “turn on” seat vibration/oscillation at pre-selected 15 or 30 minute intervals for one-three minutes of controlled oscillation at a time lasting up to three plus hour for rides between recharging and as long as body weight is on seat. Three plus hours usage presumes a fully recharged battery.

In the preferred embodiment the on/off is digital control and programmable controls and recharge connection are at the backside of seat under the lowest lip of seat. See FIG. 4a./4b./4c. Rheostat or non-digital controls alternatively may be used.

Full programmable control allows 1. Seat sensor/vibratory automatic intermittent activation as discussed above via digital selection; 2. Multiple speed selections done digitally allow more or less intense seat vibration/oscillation. ie., the higher number of strokes per minute equals greater vibration. For example, 5000 strokes per minute provides more vibration than 1500 strokes per minute. Optimal vibration/oscillation will range from 1100 to 18000 strokes per minute: 3. Wavelength of vibration may be selected digitally as “constant” providing the same vibratory/oscillatory intensity stimulation throughout the activation period. Oscillatory Rpm's around 2800 are optimal for maximum physiological node drainage and comfort. This increases oxygenation and blood flow to the sore anatomical area where anatomical muscle/node drainage occurs. Due to body weight on the seat is the nodes/nerves are occluded allowing muscle toxin build up, in all present bicycle seat no matter the seat configurations or materials. Or Rpm's of oscillation/amplitude and duty cycle control of the wavelength of oscillation may be digitally selected to Rhythmically go up and down in intensity during the activation period providing more soothing action to the muscles. Therapeutic action of the muscles by controlling oscillation Rpm's/ amplitude or duty cycle control wavelength allowing intermittent bursts of oscillation for example every 2 seconds for a 1-2 minute period as long as being ridden is yet another possible function. All functions as described herewith are examples with ultimate or optimal functions having no real limitations but is dictated per bicycle seat type and anatomical needs are to provide minimization of soreness/numbness and maximization of comfort.

The primary recharging power supply for the vibratory/oscillatory tube part of the seat is the preferred embodiment and is a Ni-Cad battery, rechargeable electronically. The battery is within the seat tube itself. The tube also contains the vibratory/oscillatory mechanism for the seat. The tube can be snapped in/out of or locked in/locked out of seat's molded tunnel placement. As conceived recharging maybe performed with the tube in place when it is a part of the seat itself. Or recharging of the tube's power may be external or remote from the seat itself similar to recharging cell phones and or electronic toothbrushes. When recharging is part of the seat, see oscillating tube-recharging connection in FIGS. 1-2. When oscillating tube is recharging remotely away from seat, the tube is placed within an electronic recharging power carriage similar to a remote carriage used for recharging cell phones and toothbrushes. Or recharging can be performed when using a recharging unit as part of a cord similar to recharging laptop computer batteries. Tube may operate via a DC power connection with or without the cord. Such recharging sources are well known in the art, and therefore will not be described in detail herein. An alternative recharging power source embodiment maybe selected with the tube placed within the bike seat for recharging and not done remotely from the seat or vise-a-versa only recharging remotely and not when the tube is part of the seat.

FIG. 6 Bottom View of Motorcycle Saddle The preferred embodiment of said roller-wheel/ball and track system would function front to back within tracks. Tracks may be molded of plastic, composite material or other suitable material to be optimally integrated within saddle. Alternatively a circularly or any other layout of wheels/balls on underside of seat to provide optimal massage and comfort with state of art motors to drive wheel function. Housing for motors may cover multiple sets of tracks to afford optimal state of art motors. Digitally controlled and programmed functions may be kneading, rolling, percussion or compression as standard replicating massage actions. For large bicycle saddles such as recumbent bike saddles and large bicycle comfort saddle types, the roller wheel and tracking may be optimal alternative for comfort. Whereas, power source will be rechargeable ni-cad for bicycles and basically the same as for vibration and oscillation functions, the power source for a motorcycle, is engine's battery/generator. The same embodiments with dimensional differences for vibration/oscillation saddle actions/functions may interchangeably be integrated in smooth riding or other motorcycle saddles when desired. Still another embodiment shows the footprints of buffering or isolation mechanisms at the basepan of motorcycle saddles that are electronically controlled and synchronized to the engines Rpm's. This buffering mechanism cancels out too much vibration at the seat level originating from the engine and frame frequently found on rough riding motorcycles like some Harley's. The buffering can intermittently allow vibration/oscillation to come through to the otherwise smooth riding controlled seat to maximize comfort, minimize soreness and numbness just as vibratory/oscillatory functions found on bicycle saddles in FIGS. 1-5. All above may also apply to backrests on motorcycles. Actual saddle dimensions and configurations are dictated by the frame of various brands and models of motorcycles

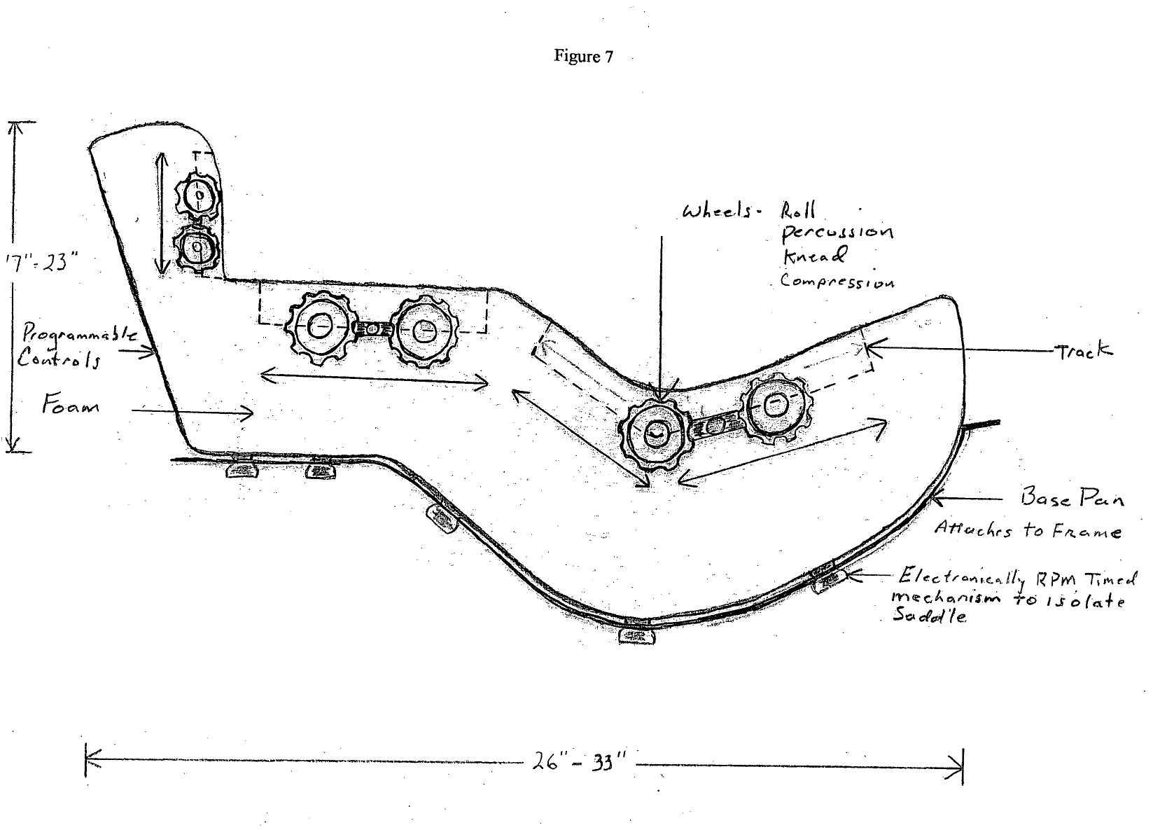

FIG. 7 Side View of Motorcycle Saddle. All in the Bottom View narrative above applies to Side View. The preferred embodiment has the wheels tracking through the foam standardized for most motorcycle seats as seen in side view. In this view the footprints of the isolation and/or buffering mechanisms synchronized to the engine to cancel out vibration are clearly displayed. The cancellation mode will optionally only be incorporated in selected rough riding motorcycles. Base pans are common to all motorcycles as the platform interface for the saddle configured to the motorcycles frame and shape. Above also applies to backrests and actual dimensions and configurations are dictated by the frame of various brands and models of motorcycles.

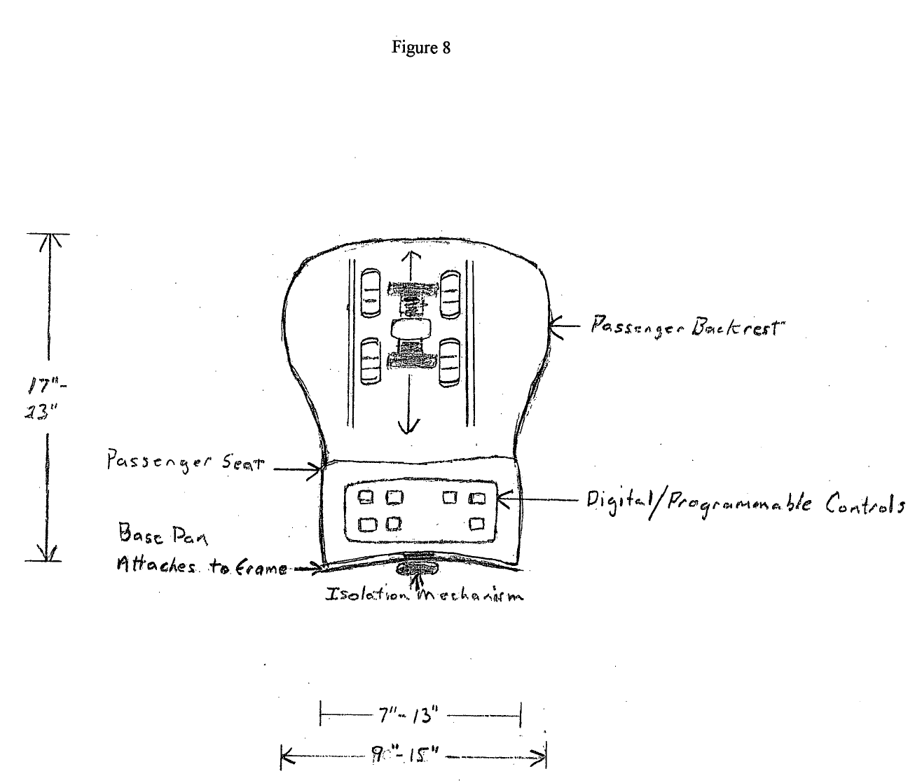

FIG. 8 Rear End View Motorcycle Saddle All narrative above in the FIG. 6 Bottom and FIG. 7 Side View applies to the End View. The preferred embodiment has Programmable Digital Control Panel located at the back and end of the saddle as pictured. Or another embodiment has the controls as a part of motorcycle's standard instrument display panel. Functions may run all the time or only intermittently at set times for set duration programs or only when selected to be operational ie. “turned on.” Functional controls may include: “On/Off; Oscillation Mode of One speed optimized at 2800 Rpm's, Therapeutic or Rhythmic etc., Wheel Mode of Roll, Knead, Percussion or Compression; and Isolation Mode Program or other. Selected or optimal functions need to be determined at prototype testing and development but all of the above may be included.

The descriptions above and the accompanying drawings should be interpreted in the illustrative and not the limited sense. While the invention has been disclosed in connection with an embodiment or embodiments thereof, it should be understood by those skilled in the art that there may be other embodiments which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A bicycle saddle/seat with an electronically powered vibrating/oscillating mechanism comprised of:
a digital programmable seat control bar activates,
a power source to drive vibratory/oscillating motor mechanism within,
a vibratory/oscillating tube integrated within a concave integrated molded tube tunnel affixed to or running within the underside seat plastic front to back the length of the bicycle seat; wherein
upon rider activation of the tube vibrating/oscillating mechanism within and by virtue of it's affixation/integration within plastic underside of the seat having contact at points appropriate with the metal rod infrastructure on the underside of all bicycle seats, thus the entire seat vibrates/oscillates upon activation.

2. The vibrating/oscillating mechanism within the tube, tube tunnel and one with the seat of claim 1 wherein said power supply also within the tube comprises a ni-cad rechargeable battery, solar recharging or bicycle motion recharging.

3. The vibrating/oscillating seat of claim 1 wherein said ni-cad recharging may be done with the vibratory/oscillatory tube locked in the seat tunnel or snapped out and may be recharged remotely away from the seat. On occasion the oscillating tube with ni-cad rechargeable batteries may be replaced when battery no longer accepts recharging.

4. The vibrating/oscillating seat of claim 1 wherein Vibrating/oscillating motor within tube/seat vibrates at frequencies of 1100 to 18000 Rpm's/strokes per minute.

5. The vibrating/oscillating seat of claim 1 wherein programmable digital controls activate vibration Rpm's/frequency, amplitude, duty cycle and wavelength of vibrations which strokes per minute are vertical to or horizontal with the saddle surface upon which rider sits.

6. The vibrating/oscillating seat of claim 1 wherein Programmable/digital controls allow automatic activation of preselected vibration/oscillation periods of one-half minute to 3 minutes each and at 15 to 30 minute intervals more or less of three plus hours of operation.

7. The vibrating/oscillating seat of claim 1 wherein programmable controls allows automatic activation and deactivation based on seat sensor/body weight bearing or simple on/off digital activation of frequency and wave length of vibrations.

8. The vibrating/oscillating seat of claim 1 wherein two motor approaches either pizo electric motion or electric motor with eccentric offset weight.

9. The vibrating/oscillating seat in claim 1 wherein controlling as necessary to have sufficient battery power and/or, a buffering, redirecting, isolation or nodulized mechanism may be integrated when necessary to minimize the principle of “energy goes to the lower mass” ie., energy going to lighter bicycle frame as it relates to the heavier rider as it is to be directed.

10. The vibrating/oscillating seat in claim 1 wherein may be integrated into bicycle saddles present or future comprised of various materials plastic, composites, gel, foam, leather, neoprene or spring supported as currently configured and characterized in type of saddles including: standard, anatomically correct, gender specific, racing, recumbent and comfort; for bicycle types including: Hybrid, Touring, Mountain, Comfort, Tandem, Racing, Juvenile, Standard and Recumbent.

11. The vibrating/oscillating seat in claim 1 wherein Recumbent bike saddles are larger, chair like with wide seat bottoms and seat backs. Either oscillating tube concept as above or roller wheel with tracks. Rollers may roll, knead, percuss, or operate in a compression manner replicating acceptable massage actions.

12. The vibrating/oscillating seat of claim 1 wherein the power source is a motorcycle engine generator rather than ni-cad rechargeable battery power, so too does this invention applies to motorcycle saddles/seats with vibratory/oscillatory tube, tube tunnel functions and programmability being the same as above; tube designs varying only in outside tube and tube tunnel's shape, dimensions and vibratory/oscillatory strokes per minute as needed. As envisioned design differences are for optimal operation, function and comfort of saddles that are generally larger than bicycle saddles/seats. Dual/Tri/Quad tubes/tunnels and tracks per seat may be required in the case of motorcycles.

13. The vibrating/oscillating seat of claim 1 wherein it applies to motorcycle seats/saddles, the oscillating/vibrating/rolling/cancellation functions applies to back rests found on driver and passenger seats/saddles

14. The vibrating/oscillating seat of claim 1 wherein to make saddles most comfortable, with functionality available to riders as desired above, on motorcycles having too much vibration/oscillation at the saddle, incorporate an electronic/mechanism that buffers or isolates saddle from motorcycle frame and or motor, electronically timed to the engines Rpm's so as to cancel out and smooth-out vibration in a controlled manner thus allowing vibration to come through to the saddle when wanted. Vibration may come through electronic mechanism to saddle for similar periods of, one-half to three minutes of vibration at intervals of every 15 to 30 minutes as the bicycle saddle above

15. The vibrating/oscillating seat of claim 1 wherein For motorcycle seats and larger bicycle seats such as recumbent bike saddles, Dual/Tri/Quad track or tracks may replace tube and tube tunnel above running on the underside front to back or circular rotation a sitting haunches area of saddle, enabling wheel or ball ⅛^{th} inch to 4 inches in diameter by ¼^{th} inch to four inches wide, to rotate full track length back and forth or circularly, powered by appropriate small state of art motor commonly available in the art. Said track is on underside of seat coverings for both bicycle and motorcycles and rotates/channels through tracking through foam, gel, and/or springs on underside of seat covering.

16. The vibrating/oscillating seat of claim 1 wherein Wheel/ball track and tracking, alternatively to oscillation/vibration tube and channels only, allows multi-speed massage functions of kneading rolling, percussion and compression used to optimize comfort for both bicycle and motorcycle saddles.

17. The vibrating/oscillating seat claim 1 wherein Heating and /or cooling elements, alternatively or in addition to above may be integrated on underside of bicycle or motorcycle saddles and channeled through foam, gel springs, front to back of saddle adjacent to saddle covering to conduct heat or cooling effects for facilitating massage and comfort.

18. The vibrating/oscillating seat claim 1 wherein seat oscillation in combination with a nodulized mechanism integrated at seat/seat post or Seat oscillation in combination with integrated mechanical or electrical shock absorber and/or shock absorber integrated within or without the bicycle seat post.

19. The vibrating/oscillating seat claim 1 wherein electrode integration into bicycle or motorcycle seat allowing for the conduction of electrical current via EMS electric muscle stimulation.
